(19) United States
(12) Patent Application Publication
(10) Pub. No.: US 2005/0034165 A1
(43) Pub. Date: Feb. 10, 2005

(54) Digital entertainment system

(76) Inventors: Yong-jin Kang, Suwon-si (KR); Hyung-tae Lee, Yongin-si (KR); Yang-mu Heo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/911,532

(22) Filed: Aug. 5, 2004

(30) Foreign Application Priority Data
Aug. 6, 2003 (KR) 2003-54483

(51) Int. Cl. H04N 7/173; H04N 7/18; H04N 7/16

(52) U.S. Cl. 725/111; 725/78; 725/143; 725/151

(57) ABSTRACT

Disclosed is a digital entertainment system which can receive, store and reproduce multimedia data such as broadcasts, provide diverse communication interfaces, and exchange and share data with external appliances connected thereto. In the network printer control system, an audio and video (A/V) signal processing part receives external broadcasting signals, and outputs digital data obtained through a process of channel selection and demodulation of the broadcasting signal. A data over cable service interface specification (DOCSIS) and out of band (OOB) processing part provides a communication interface according to a DOCSIS standard and for an OOB service. An MPEG processing part generates standard video signals by decoding input data by a predetermined method, and outputs the generated standard video signals to any external appliances, and a system bus communicably connects the signal processing part, the DOCSIS/OOB processing part and the MPEG processing part. A control part, communicably connected to the system bus, controls an operation of the A/V signal processing part and the MPEG processing part and performs a communication through the DOCSIS and OOB processing part.

This application claims benefit under 35 U.S.C. § 119(a) of Korean Patent Application No. 2003-54483, filed on Aug. 6, 2003, in the Korean Intellectual Property Office, the entire contents of which are hereby incorporated by reference.

### BACKGROUND OF THE INVENTION

1. Field of the Invention

The present invention relates to a digital entertainment system. More particularly, the present invention relates to a digital entertainment system which can receive, store and reproduce multimedia data, such as broadcasts, provides diverse communication interfaces, and exchanges and shares data with external appliances connected thereto.

2. Description of the Related Art

Today, domestic information environments may be considered to be interconnected environments. This means that stand-alone products and services form interdependent connections with one another. As a greater number of wide-band connections become possible, users at home can connect various kinds of hardware and devices to the Internet, and thus the levels of connectivity increase. This means that the base application for various kinds of content is being formed. In other words, various kinds of applications can be shared among users in addition to the independent use of the applications at home, so the users can enjoy entertainment through their wide-band connections to the Internet, and easily use various kinds of services.

As the information environment of the users at home becomes more high-level, the necessity for an integrated product combining a communication appliance, a computer, an audio and video appliance, and the like, is increasing. To meet this necessity, a home entertainment system has been proposed integrating such products. The home entertainment system has extended the function of the basic set top box, and can store, manage and reproduce multimedia data such as broadcast signals and multimedia data produced at home such as home videos, photographs, and so on. Accordingly, the home entertainment system may belong to the category of a home multimedia server.

However, existing home entertainment systems have limitations in providing integrated connectivity between information appliances, audio and video appliances, digital home appliances, and so on at home. Also, existing home entertainment systems have limitations in exchanging or sharing multimedia data with the distributed home appliances, and particularly with the audio and video appliances. In order to overcome the limitations as described above, a home server based on a home network is required, but a home server has not yet been commercialized for use in the home.

Meanwhile, the proliferation of new digital display appliances such as a front projector that can be used as a home cinema, a plasma display that is a wall mount type TV, a rear projection TV, and the like, have increasingly been replacing existing analog TVs. Accordingly, it is necessary to provide a digital entertainment system based on the digital compatibility of appliances which can extend the audio and video support function of existing home entertainment systems, provide a communication interface between diverse appliances, and facilitate the exchange or sharing of the multimedia data in association with such new display appliances.

### SUMMARY OF THE INVENTION

Accordingly, it is an aspect of the present invention to provide a digital entertainment system which can receive, store and reproduce multimedia data such as broadcasts, and provide a communications interface with a variety of external appliances.

In order to achieve the above aspects and or other features of the present invention, a digital entertainment system, according to an embodiment of the present invention, includes an audio and video (A/V) signal processing part. The A/V signal processing part receives external broadcast signals, and outputs digital data obtained through a process of channel selection and demodulation of the broadcast signal. The digital entertainment system also may include a data over cable service interface specification (DOCSIS) and an out of band (OOB) processing part for providing a communication interface according to a DOCSIS standard and for an OOB service. To generate standard video signals, the digital entertainment system also includes an MPEG processing part. The standard video signals are generated by decoding input data by a predetermined method, and outputting the generated standard video signals to an external device. A system bus communicably connects the A/V signal processing part, the DOCSIS and OOB processing part, the MPEG processing part, and a control part. The control part, communicably connected to the system bus, controls the operation of the A/V signal processing part and the MPEG processing part, and communicates through the DOCSIS and OOB processing part.

Preferably, the digital entertainment system according to an embodiment of the present invention further comprises a communication part, communicably connected to the system bus, for providing an interface for communication between the control part and external appliances. The communication part preferably includes at least one of a universal serial bus (USB), a home Phone-line Network Alliance (PNA), a wireless LAN (WLAN) and an RS-232C interface, and enables connection to a variety of external appliances.

Preferably, the digital entertainment system according to an embodiment of the present invention further comprises a storage medium for storing data, wherein the MPEG processing part stores the input data in the storage medium, and generates the standard video signals by reading the data stored in the storage medium and decoding the readout data by a predetermined method. In this case, a hard disc drive may be used as the storage medium. Also, the digital entertainment system according to the present invention may further comprise a digital versatile disc (DVD) part for recording and reading data on a recording medium, wherein the MPEG processing part generates the standard video signals by decoding the data outputted from the DVD part by a predetermined method. The recording medium may also include a video compact disc (VCD), a compact disc (CD) and a recordable compact disc (CD-R) in addition to the DVD.

The MPEG processing part can generate a variety of standard video signals such as signals of Y/Pb/Pr, S-video, composite, S/PDIF, and the like, and an MPEG-2 decoding method preferably can be used for generating the standard video signals.

The A/V signal processing part may include a plurality of analog tuners and digital tuners for selecting different channels from the external broadcasting signals. The A/V signal processing part also enables simultaneous viewing of different broadcasting signals or storage of one broadcasting signal during viewing of another broadcasting signal.

The MPEG processing part may include an MPEG decoder for generating the standard video signals by decoding the input signal by a predetermined method. In addition the MPEG part may include an MC [Please define the acronym MC.] part for descrambling a scrambled signal output from the A/V signal processing part, and for transferring a descrambled signal to the MPEG decoder. The MPEG part may also include a memory for storing a program required for the operation of the MPEG decoder, as well as, data.

Also, the control part may include a processor with a memory for storing a program required for an operation of the processor and data. The control part may also include a Caller ID (CID) part for providing an interface related to a caller display service. In this case, the processor may be a processor of an MIPS architecture that provides a LAN interface.

Also, the system bus may be a peripheral component interconnect (PCI) bus.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating the exterior of an exemplary digital entertainment system according to an embodiment of the present invention;

FIG. 2 is a view illustrating an example of an operational environment of an exemplary digital entertainment system according to an embodiment of the present invention;

FIG. 3 is a view illustrating an exemplary digital entertainment system connected to external appliances according to an embodiment of the present invention;

FIG. 4 is a block diagram of an exemplary digital entertainment system according to an embodiment of the present invention; and

FIG. 5 is a detailed block diagram of an exemplary digital entertainment system according to an embodiment of the present invention.

Throughout the drawings, it should be understood that like reference numbers are used to refer to like features and structures.

### DETAILED DESCRIPTION OF THE PREFERRED EMBODIMENTS

Certain embodiments of the present invention will now be described in greater detail with reference to the accompanying drawings.

In the following description, the same drawing reference numerals are used for the same elements even in different drawings. The matters defined in the description such as a detailed construction and elements are only provided to assist in a comprehensive understanding of the invention, and should not limit the invention. Thus, it is apparent that the embodiments of the present invention can be carried out without those defined matters. Also, descriptions of well-known functions or constructions are omitted for a better understanding of the invention.

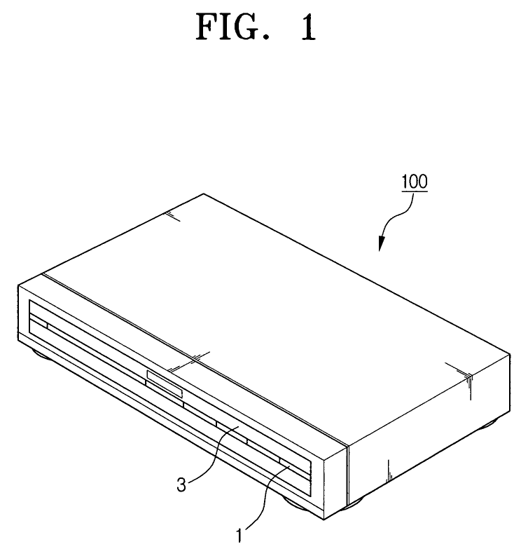

FIG. 1 is a view illustrating the exterior of an exemplary digital entertainment system according to an embodiment of the present invention. Referring to FIG. 1, the digital entertainment system 100 according to an embodiment of the present invention has a shape similar to an existing DVD player as a whole, and has a manipulation switch 1 for controlling an operation of the system and a display 3 for displaying operation-related information installed on the front side of the system. The operation of the digital entertainment system 100 can be controlled through a remote controller or an external appliance connected thereto in addition to the manipulation switch 1. Although not illustrated in the drawing, connection terminals for connecting to external appliances such as a television receiver (TV), a computer, and the like, are installed on the rear side of the system 100.

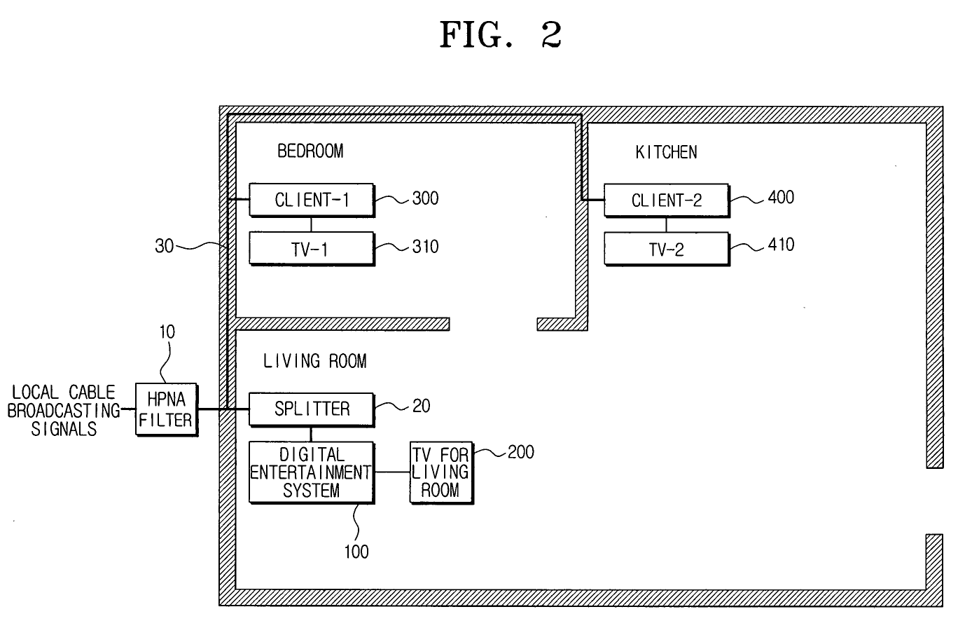

FIG. 2 is a view illustrating an example of an operational environment of an exemplary digital entertainment system according to an embodiment of the present invention.

Referring to FIG. 2, the digital entertainment system 100 according to an embodiment of the present invention is installed in a living room of a house. Local cable broadcasting signals provided by a local cable broadcasting agent are input to the digital entertainment system 100 through an HPNA filter 10 and a splitter 20. The living room TV 200 is connected to the digital entertainment system 100. The HPNA filter 10, which is installed by the local cable broadcasting agent, is used to provide the broadcasting signal only to the home that is under contract with the local cable broadcasting agent. The splitter 20 is used for signal distribution.

A client-1 300 is installed in a bedroom, and a TV-1 310 is connected to the client-1 300. A client-2 400 is installed in a kitchen, and a TV-2 410 is connected to the client-2 400. Low-priced equipment that is incompatible with some of the functions of the digital entertainment system 100 may be used as the client-1 300 or the client-2 400. It is possible for the client-1 300 and the client-2 400 to share multimedia data stored in the digital entertainment system 100 through a transmission line such as a telephone line in the dwelling. Of course, the locations of client-1 and client-2 are exemplary. Client-1 and client-2 may be located anywhere within the dwelling as desired by the user.

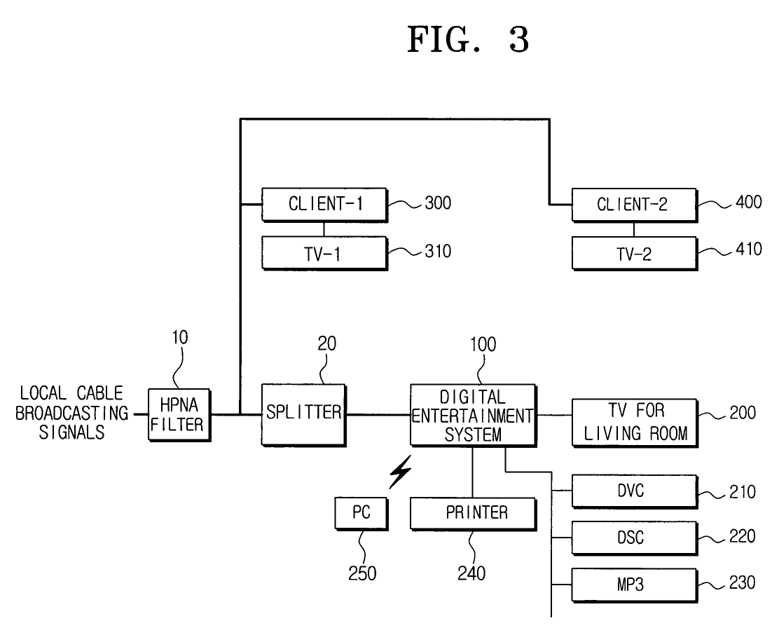

FIG. 3 is a view illustrating the exemplary digital entertainment system 100 connected to diverse external appliances according to an embodiment of the present invention. Referring to FIG. 3, in addition to the TV for the living room 200, a Digital Video Camera (DVC) 210, a Digital Still Camera (DSC) 220, an MP3 device 230, and so on, are connectable to the digital entertainment system 100 using an IEEE 1394 or Universal Serial Bus (USB) interface. A printer 240 can be connected to the digital entertainment system through the USB interface. Also, the digital entertainment system 100 can communicate with a PC 250 by a wireless communication such as a Wireless LAN (WLAN) and so on. The digital entertainment system 100 can transmit and receive data and control signals to and from the client-1 300 and the client-2 400 through the splitter 20.

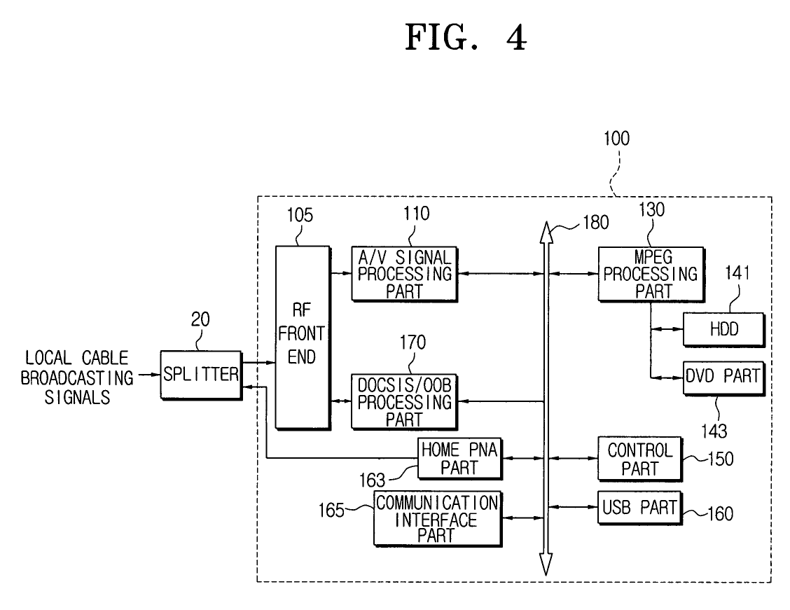

FIG. 4 is a block diagram of the exemplary digital entertainment system according to an embodiment of the present invention. Referring to FIG. 4, the digital entertainment system 100 according to an embodiment of the present invention is provided with an RF front end 105, an A/V signal processing part 110, an MPEG processing part 130, a Hard Disc Drive (HDD ) 141, a DVD part 143, a control part 150, a USB part 160, a home PNA part 163, a communication interface part 165, and a DOCSIS/OOB processing part 170, which are communicably connected to one another through and transmitting the demodulated signal through a system bus 180.

The RF front end 105 distributes broadcasting signals input through the splitter 20 to the A/V signal processing part 110 and the DOCSIS/OOB processing part 170, and transfers signals output from the DOCSIS/OOB processing part 130 to the external appliances.

The A/V signal processing part 110 is preferably provided with two digital tuners and two analog tuners. The A/V signal processing part 110 selects a channel desired by a user from among the channels of the input broadcast signals, and outputs digital data generated by demodulating the signal of the selected channel through the system bus 180.

The MPEG processing part 130 generates standard video signals by decoding the data input through the system bus 180 according to a predetermined method, such as MPEG. Also, the MPEG processing part 130 stores the data input through the system bus 180 in the HDD 141, or it generates the standard video signals by decoding the data loaded from the HDD 141 or the DVD part 143. The standard video signals generated from the MPEG processing part 130 are output to the external appliances through the connection terminals.

The HDD 141 is used as the storage medium for storing the data compressed by the MPEG processing part 130. By using the HDD 141 as the storage medium, instead of a magnetic tape, a Personal Video Recorder (PVR) function can be provided. The PVR function is basically to store broadcast programs transmitted from broadcast stations and then to view the programs after a predetermined time. The PVR function also facilitates a search for or the capability to edit a desired part of the stored broadcasting programs, and enables scheduling recordings by receiving the latest broadcasting schedule from time to time. Further, the PVR function enables a simultaneous recording of several programs, while allowing an instantaneous stop or a repeated reviewing of a scene several seconds to several minutes ago during a live broadcasting. The above features allow interactive viewing of the broadcasts in association with the broadcasting agent.

The DVD part 143 performs a reading operation of the data recorded in the recording medium such as a Digital Video Disc (DVD) and functions as a general DVD player. The DVD part 143 may record data on and reproduce data from various recording media such as a CD, VCD, CD-R, etc., in addition to DVDs.

The USB part 160 is a kind of serial port, and provides a USB interface having a plug and play function. One USB port can accommodate up to 127 diverse external devices. The USB port 160 accommodates appliances that require high-speed transmission such as a scanner, a video appliance and a printer. Likewise, devices that require a relatively low-speed transmission such as a keyboard, a joystick, a mouse, and so on, can also be connected to the USB port.

The home PNA part 163 provides a home PNA interface. The Home PNA enables data transmission in a frequency band different from that of an audio signal using the existing phone line. Preferably, using the existing phone line, the home PNA enables communication among two or more devices without installing a separate cable or hub, and makes it possible for the devices to share resources such as the hard disc and the printer. The home PNA interface provided by the home PNA part 163 enables the exchange and sharing of data between the digital entertainment system and the client.

The communication interface part 165 provides a wireless communication interface such as WLAN or Bluetooth, or an IEEE 1394 interface. The IEEE 1394 interface supports the plug and play functionality in the same manner as the USB port, and one port can accommodate up to 53 devices.

The DOCSIS/OOB processing part 170 provides an interface according to the DOCSIS standard and an interface for an OOB service. The DOCSIS means the modem standard for a cable modem prepared by Multimedia Cable Network System partners (MCNS). The modulation type used in the DOCSIS may be a 64/256 quadrature amplitude modulation (QAM) and a quadrature phase shift keying (QPSK)/16QAM.

The system bus 180 communicably connects the A/V signal processing part 110, the MPEG processing part 130, the control part 150, the USB part 160, the home PNA part 163, and the communication interface part 165. A Peripheral Component Interconnect (PCI) bus may be used as the system bus 180. The control part 150 controls the operation of and runs the application programs for the digital entertainment system 100

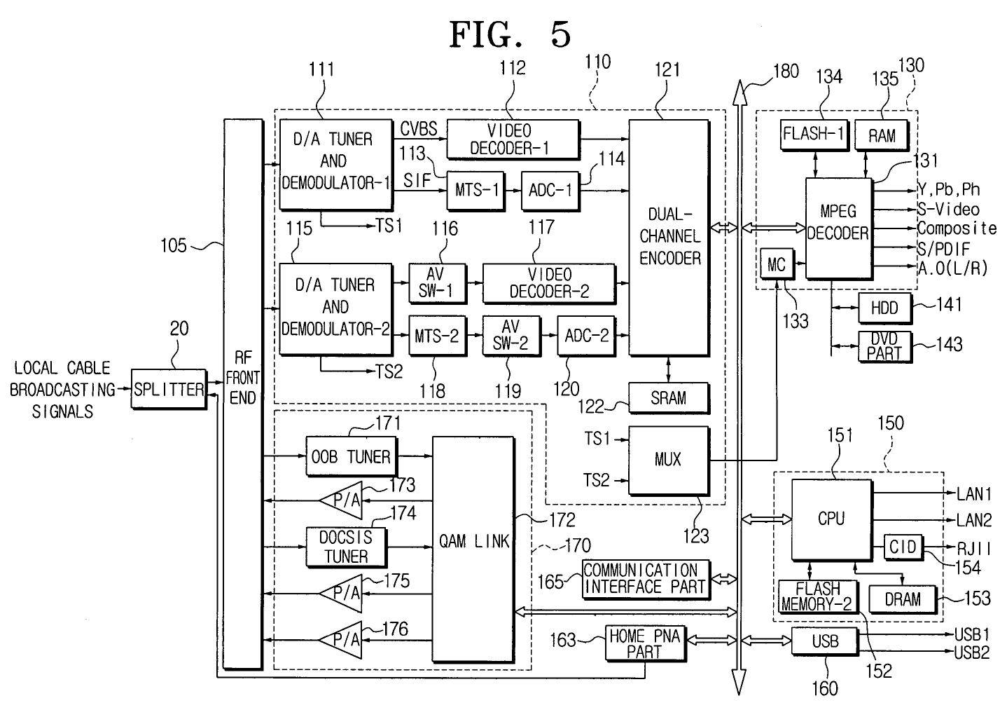

FIG. 5 is a detailed block diagram of the digital entertainment system according to an embodiment of the present invention. In FIG. 5, the same reference numerals are used to refer to the same parts as those in FIG. 4. The A/V signal processing part 110 includes digital/analog (D/A) tuner and demodulator-1 111, a video decoder-1 112, a Multi Television System (MTS)-1 113, an analog-to-digital converter (ADC)-1 114, D/A tuner and demodulator-2 115, an A/V switch-1 116, a video decoder-2 117, an MTS-2 118, an A/V switch-2 119, an ADC-2 120, a dual-channel encoder 121, an SRAM 122 and a multiplexer (MUX) 123.

The D/A tuner and demodulator-1 111 is provided with a digital tuner and an analog tuner. The D/A tuner and demodulator-1 111 selects a channel desired by the user from among the input broadcast channel signals, and demodulates the signal of the selected channel. Through the D/A tuner and demodulator-1 111, a Color, Video, Burst and Sync (CVBS) signal and a Source or Standard Input Format (SIF) signal are output, and a transport stream (TS) signal TS 1 is output through the digital tuner. The transport stream is one of the multiplexing methods prescribed in MPEG-2, which is defined for an environment where a transmission error such as a noise error or data loss may occur.

The video decoder-1 112 receives the CVBS signal that is a composite video signal output from the D/A tuner and demodulator-1 111, analyzes the information of the compressed sequential scenes stored as a video packet. The video decoder-1 112 transfers the CVBS signal to the dual-channel encoder 121 in a signal format the size of which matches a TV screen that may have a different resolution. The video decoder-1 112 supports a still picture function, and thus can preferably be used for an interactive TV advertisement. The MTS-1 113 receives the SIF signal from the D/A tuner and demodulator-1 111, and separates a multi-voice signal from the SIF signal. The ADC-1 114 converts the analog signal output from the MTS-1 113 into a digital signal, and transfers the digital signal to the dual-channel encoder 121.

The D/A tuner and demodulator-2 115, the video decoder-2 117, the MTS-2 118 and the ADC-2 120 have the same functions as the D/A tuner and demodulator-1 111, the video decoder-1 112, the MTS-1 113 and the ADC-1 114, respectively. Also, the A/V switch-1 116 and the A/V switch-2 119 are used to change the A/V connection terminal installed on the rear side of the system to the A/V connection terminal installed on the front side of the system, and vice versa. By providing a plurality of tuners that operate independently, it is possible to simultaneously select and view different broadcasts, or to store the contents of one broadcast signal while viewing another broadcast signal.

The dual-channel encoder 121 encodes the input signal, and transfers the encoded signal to the MPEG decoder 131 through the system bus 180. The SRAM 122 stores and outputs the data required for the operation of the dual-channel encoder 121.

The TS1 signal output from the D/A tuner and demodulator-1 111 and the TS2 signal output from the D/A tuner and demodulator-2 115 are transferred to the MUX 123. The MUX 123 selectively transfers one of the TS1 and TS2 signals to the MC 133.

The MPEG processing part 130 includes an MPEG decoder 131, an MC 133, a flash-1 134 and a RAM 135. The MPEG decoder 131 decodes the signal input through the system bus 180 preferably according to the MPEG-2 method. The MPEG decoder 131 preferably generates a variety of standard video signals such as Y/Pb/Pr, S-video, composite, S/PDIF, and the like. Also, the MPEG decoder 131 stores the data input through the system bus 180 in the HDD 141, and generates the standard video signals by expanding the compressed data stored on the HDD 141. In addition, the MPEG decoder 131 may generate the standard video signals by decoding the data read out from the DVD part 143. The standard video signals generated by the MPEG decoder 131 are output to any external appliances through the connection terminal, and displayed on a display device connected through the connection terminal. The MC 133, which is a kind of descrambler well known in the art, descrambles the scrambled signal and transfers the descrambled signal to the MPEG decoder 131. The flash-1 134 and the RAM 135 preferably store programs required for the operation of the MPEG decoder 131 and data.

The control part 150 is provided with a CPU 151, a flash memory-2 152, a DRAM 153 and a Caller ID (CID) 154. The CPU 151 performs an initialization process and runs application programs through the system bus 180, and controls the operation of the digital entertainment system 100. A processor with a 64-bit MIPS architecture that provides a LAN interface may be used as the CPU 151.

The flash memory-2 152 and the DRAM 153 are used as processor memories required for the operation of the CPU 151. The flash memory-2 152 is preferably a flash memory that can erase or correct data in the unit of a data block. An Operating System (OS) and the like can preferably be downloaded to the flash-2 152 whenever an upgrade of the OS stored on the flash memory-2 152 is required.

The CID 154 provides an interface related to a caller display service for displaying the phone number of the caller on a telephone or a display terminal of the receiver before the call. The output of the CID 154 is preferably applied to an RJ11 phone jack.

The DOCSIS/OOB processing part 170 includes an OOB tuner 171, a QAM link 172, a DOCSIS tuner 174 and power amplifiers (P/A) 173, 174 and 176.

The DOCSIS tuner 171 provides an interface according to the DOCSIS standard. The OOB tuner 174 provides an interface for facilitating a data transmission to an OOB service provider to enable a series of interactive services, and preferably uses a frequency band of 100 to 350 MHz. The QAM link 172 performs a data link control with respect to a QAM-modulated signal outputted through the DOCSIS tuner 171 and the OOB tuner 174. The power amplifiers 173, 174 and 176 are used to amplify signals transferred to any external appliances or devices.

According to an embodiment of the present invention of the above-described construction, several broadcast signals are simultaneously received and reproduced through the A/V signal processing part 110, or stored on the HDD 141. The stored data can be exchanged and shared with the clients or the external appliances through the home PNA 163. Also, the Internet or the OOB service can be used through the DOCSIS/OOB processing part 170, and the data can be exchanged and shared with the external appliances through the USB part 160, the home PNA part 163, the communication interface part 165, and the like.

As described above, the digital entertainment system according to the embodiments of the present invention is preferably provided with a plurality of tuners, which enables the simultaneous viewing of several broadcast signals, or the storing of one broadcast signal on a storage medium while viewing another broadcast signal. Also, the digital entertainment system according to an embodiment of the present invention can provide a Personal Video Recorder (PVR) function using a hard disc as a storage medium. Also, the digital entertainment system according to an embodiment of the present invention can reproduce the data stored on a variety of recording media such as DVD and so on. Additionally, the digital entertainment system 100 can exchange and share the stored multimedia data with clients using existing phone lines through the home PNA 163. A separate line is not required to be provided. Also, the digital entertainment system 100 according to an embodiment of the present invention can exchange and share the data with a variety of external appliances by providing communication interfaces for the external appliances.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A digital entertainment system comprising:
an audio video (A/V) signal processing part for receiving external broadcast signals, and outputting digital data obtained through a process of channel selection and demodulation of the broadcasting signal;
a data over cable service interface specification (DOCSIS) and out of band (OOB) processing part for providing a communication interface according to a DOCSIS standard and an interface for an OOB service;
an MPEG processing part for generating standard video signals by decoding input data by a predetermined method, and outputs the generated standard video signals to at least one external appliance;
a system bus for communicably connecting the A/V signal processing part, the DOCSIS and OOB processing part and the MPEG processing part; and
a control part, communicably connected to the system bus, for controlling the operation of the A/V signal processing part, the MPEG processing part, and performing communications through the DOCSIS/OOB processing part.

2. The digital entertainment system as claimed in claim 1, further comprising a communication part, communicably connected to the system bus, for providing an interface for communication between said control part and said external appliances.

3. The digital entertainment system as claimed in claim 2, wherein the communication part includes at least one of a universal serial bus (USB), a home PNA, a wireless LAN (WLAN) and an RS-232C interface.

4. The digital entertainment system as claimed in claim 1, further comprising a storage medium for storing data;
wherein the MPEG processing part stores the input data on the storage medium, generates the standard video signals by reading the data stored in the storage medium and decoding the readout data by a predetermined method.

5. The digital entertainment system as claimed in claim 4, wherein the storage medium is a hard disc drive.

6. The digital entertainment system as claimed in claim 1, further comprising a DVD part for recording and reading data on a recording medium;
wherein the MPEG processing part generates the standard video signals by decoding the data outputted from the DVD part by said predetermined method.

7. The digital entertainment system as claimed in claim 6, wherein the recording medium includes a DVD, a VCD, a CD and a CD-R.

8. The digital entertainment system as claimed in claim 1, wherein the standard video signal is selected from the group of signal formats consisting of Y/Pb/Pr, S-video, composite and S/PDIF.

9. The digital entertainment system as claimed in claim 1, wherein the predetermined method is an MPEG-2 decoding method.

10. The digital entertainment system as claimed in claim 1, wherein the AN signal processing part comprises a plurality of analog tuners for selecting different channels from the external broadcasting signals, respectively, and digital tuners.

11. The digital entertainment system as claimed in claim 1, wherein the MPEG processing part comprises:
an MPEG decoder for generating the standard video signals by decoding the input signal by the predetermined method;
an MC part for descrambling a scrambled signal outputted from the A/V signal processing part, and transferring a descrambled signal to the MPEG decoder; and
a memory for storing data and a program required for an operation of the MPEG decoder and the data.

12. The digital entertainment system as claimed in claim 1, wherein the control part comprises a processor, a processor memory for storing data and a program required for an operation of the processor and the data, and a caller ID (CID) part for providing an interface related to a caller display service.

13. The digital entertainment system as claimed in claim 1, wherein the processor is a processor of an MIPS architecture that provides a LAN interface.

14. The digital entertainment system as claimed in claim 1, wherein the system bus may be a peripheral component interconnect (PCI) bus.

15. A digital entertainment method comprising the steps of:
receiving external broadcast signals by an audio/video (A/V) signal processing part that outputs digital data obtained through a process of channel selection and demodulation of said broadcasting signals;
providing a communication interface according to a data over cable service interface specification (DOCSIS) and out of band (OOB) processing part for a DOCSIS standard and an interface for an OOB service;
generating standard video signals by decoding input data by a predetermined method, and sending the generated standard video signals to at least one external appliance or device;
communicably connecting the A/V signal processing part, the DOCSIS and OOB processing part and the MPEG processing part to a system bus; and
controlling the operation of the A/V signal processing part, the MPEG processing part, and performing communications through the DOCSIS/OOB processing part through a control part, communicably connected to the system bus.

16. The method according to claim 15, further comprising:
providing an interface for communication between the control part and external appliances.

17. The method according to claim 15, wherein the generating step further comprises:
storing the input data on a storage medium;
reading the data stored on the storage medium; and
generating standard video signals by decoding the readout data by a predetermined method.
